(19) United States
(12) Patent Application Publication
(10) Pub. No.: US 2016/0027134 A1
(43) Pub. Date: Jan. 28, 2016

(54) SYSTEM AND METHOD FOR MANAGEMENT OF REMOTE CONFERENCES

(71) Applicant: CourtCall, LLC, Los Angeles, CA (US)

(72) Inventors: Robert Alvarado, Rancho Palos Verdes, CA (US); Matthew Wapnick, Los Angeles, CA (US); Mark Wapnick, Los Angeles, CA (US); Jason Wood, Doylestown, PA (US)

(21) Appl. No.: 14/341,306

(22) Filed: Jul. 25, 2014

(51) Int. Cl. G06Q 50/18; H04N 7/15; G06Q 10/10

(52) U.S. Cl. CPC G06Q 50/18; G06Q 10/101; H04N 7/15

(57) ABSTRACT

A remote conference management system supporting some combination of text, audio, and video conferencing is disclosed. Using the disclosed technology, a conference can be organized such that during different sessions of the conference, some participants may be active and others inactive. The disclosed technology can be used in the context of a dispute resolution tribunal, such as in court, alternative dispute resolution hearing, or before an administrative body. In some embodiment which could be used in such a context, a primary conference can be used to conduct business on an active matter (e.g., a case currently being heard by a judge), while one or more subconferences could be used for private conversations between participants (e.g., settlement negotiations). In implementing the disclosed technology, a software queue and abstraction layers can provide reliable asynchronous communication with third party audio and video conference providers.

### FIELD

The disclosed technology pertains to a system for scheduling and managing a conference between multiple remote parties, and is preferably applied in support of the use of remote conferencing for interactions which would otherwise take place in a physical courtroom setting.

### BACKGROUND

Teleconferencing can be an effective way to conduct meetings between multiple remotely located parties while avoiding the time and expense of travel. Many businesses have offices scattered across a wide geographical area, and often several employees may work closely together on a task while separated by thousands of miles With teleconferencing, multiple employees can collaborate on a single task as if they were in the same room, regardless of their geographic location. While commonly referred to as teleconferencing, some collaborative conference systems may allow conferencing via typed text, such as a chat room, audio, such as a phone conference, or even video, such as a video chat room.

While valuable for many businesses in their daily pursuits, there are a number of drawbacks to currently used conference systems and techniques. For example, current conference systems are often implemented on the assumption that all participants are (or should be able to) contribute to and observe/hear a conference at all times, which can result in a conference grinding to a halt while multiple participants who want to contribute at the same time attempt to coordinate their contributions to avoid overlaps which could render them unintelligible. Similarly, current conference systems often have no good way of handling connection issues, either causing interruptions to inform participants when there has been a connection or disconnection, or not informing participants of what connections or disconnections have taken place, thereby making it impossible to know what participants are present at any given time. These and other problems, at very least, make existing conference technology less beneficial than it might otherwise be and may make it entirely inappropriate for use in some contexts. Accordingly, there is a need for improved conferencing technology which can address one or more of the problems in existing systems.

### SUMMARY

Disclosed herein are techniques which can be used in a variety of settings, including management of a remote conference during which a plurality of cases are scheduled for meetings before a judge. Such a remote conference could have a plurality of participants comprising the judge and one or more representatives for each case from the plurality of cases. In this setting, the disclosed technology could be implemented as, for example, a machine comprising a plurality of user computers and a management server. In this type of implementation, one of the user computers may be configured to display an interface operable to submit a case change request indicating that a case from the plurality of cases should be designed as active. Similarly, a management server could be configured to maintain data identifying a case from the plurality of cases as active, and to, upon receiving the case change request, implement the case change request by performing acts comprising modifying the abilities of participants in the remote conference to contribute to communications with the judge. Of course, the teachings of this disclosure are capable of being implemented in other forms as well, such as various systems, methods and articles of manufacture (e.g., non-transitory computer readable media), and the protection accorded by this document should not be limited to the specific types of implementations described in this summary.

### BRIEF DESCRIPTION OF THE DRAWINGS

The drawings and detailed description that follow are intended to be merely illustrative and are not intended to limit the scope of the invention as contemplated by the inventors.

FIG. 1 is a schematic diagram of an exemplary system configured to manage a remote conference.

FIG. 2 is a flowchart of a set of high-level steps that a system could perform to manage a remote conference.

FIG. 3 is a flowchart of a set of steps that a system could perform to schedule a remote conference.

FIG. 4 is a flowchart of a set of steps that a system could perform to initiate a remote conference.

FIG. 5 is a flowchart of a set of steps that a system could perform to aid in managing state changes.

FIG. 6 is a flowchart of a set of steps that a system could perform to manage reconnection of a disconnected participant.

FIG. 7 is a screen capture of an example interface for participating in a remote conference from the perspective of an attorney.

FIG. 8 is a screen capture of an example interface for participating in and managing a remote conference from the perspective of a judge.

FIG. 9 is a screen capture of an example interface for participating in and managing a remote conference from the perspective of a judge.

FIG. 10 is a screen capture of an example interface for participating in and managing a remote conference from the perspective of a judge.

FIG. 11 is a screen capture of an example interface for participating in a remote conference from the perspective of an attorney.

FIG. 12 is a screen capture of an example interface for participating in a remote conference from the perspective of an attorney.

FIG. 13 is a screen capture of an example interface for participating in and managing a remote conference from the perspective of a moderator.

FIG. 14 is a screen capture of an example interface for participating in and managing a remote conference from the perspective of a moderator.

FIG. 15 is a screen capture of an example interface for participating in and managing a remote conference from the perspective of a moderator.

FIG. 16 is a screen capture of an example interface for participating in and managing a remote conference from the perspective of a moderator.

FIG. 17 is a screen capture of an example interface for participating in and managing a remote conference from the perspective of a moderator.

### DETAILED DESCRIPTION

The inventors have conceived of novel technology that, for the purpose of illustration, is disclosed herein as applied in the context of using remote conferencing to facilitate interactions between judges and attorneys which would otherwise take place in a physical courtroom setting. While the application of the disclosed technology in that context satisfies a long felt but unmet need, it should be understood that the disclosed technology is not limited to being applied only in that context. For example, rather than only being useful for facilitating interactions between judges and attorneys which would otherwise take place in a physical courtroom setting, the disclosed technology can also be used to facilitate interactions such as business negotiations, competitive games, or other types of interactions which would be negatively affected by the drawbacks of currently used conference systems. Similarly, even in a courtroom setting, the disclosed technology could be used for purposes other than facilitating interactions between judges and attorneys. For example, it could be used to facilitate interactions between judges and self-represented parties (or between judges, attorney and self-represented parties), or between a judge and a single attorney (e.g., for an appearance where only one attorney is present, such as a default hearing). Additionally, it is possible that the disclosed technology could be used to facilitate interactions which do, in part, take place in a physical courtroom setting. For example, the disclosed technology could be used to facilitate a remote conference between a judge and a first attorney who is present with the judge in a physical courtroom and a second attorney who is located remotely. Accordingly, the use of the inventors' technology in the context of facilitating interactions which would otherwise take place in a courtroom setting should be understood as being illustrative only, and should not be treated as implying limitations on the scope of protection accorded by this document or any related document.

Turning now to the operation of the disclosed technology, preferably, when it is used to facilitate interactions which would otherwise take place in a courtroom setting, the disclosed technology will be implemented in a manner which allows those interactions to be driven by, and synchronized with, the relevant court's calendar. For example, if a judge has meetings (e.g., motion hearings, pre-trial conferences, etc) on three cases scheduled on the same day, then those meetings would preferably be handled by setting up a single conference which would include the judge as well as the participants for each of the three cases. This single conference could be further broken down into sessions, with one session for each of the cases with a scheduled meeting, and with each of the participants (e.g., as indicated in the court's calendar) being associated with the session for his or her case.

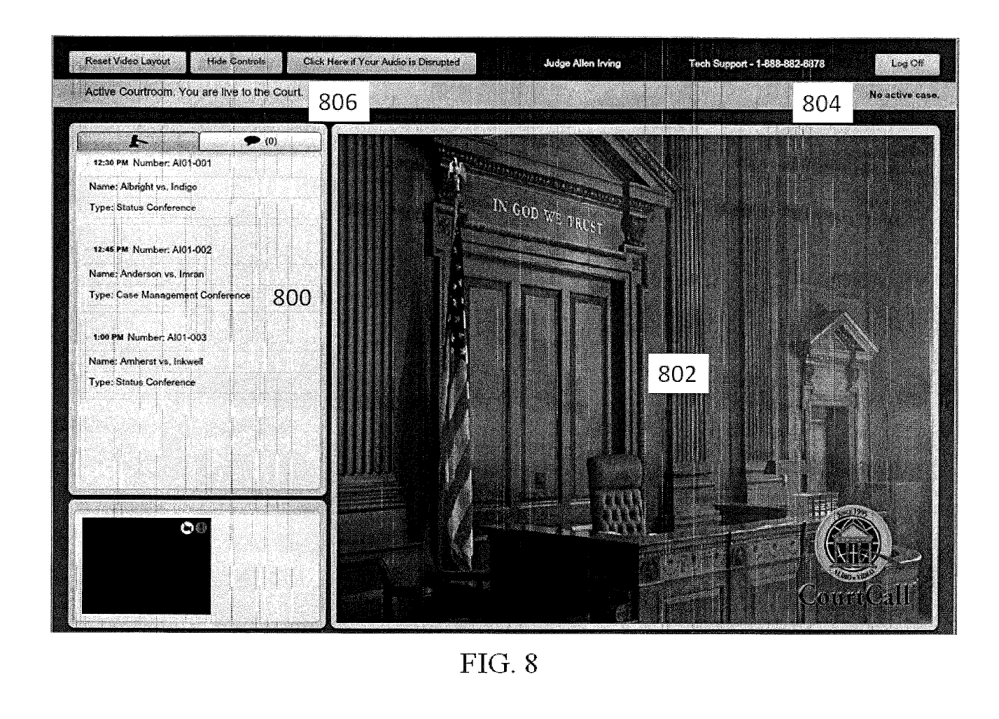

In implementations where it is used, this approach of including participants for multiple cases in a single conference organized into multiple sessions can facilitate providing an experience which is similar (and in some cases superior) to that which would be provided by a physical courtroom. For example, where participants for multiple cases are organized into individual sessions, the disclosed technology can be used to quickly switch between cases by manipulating the inputs and outputs of the conference participants on a session by session basis. In this manner, when the judge is handling a first case, that case could be designated as “active,” with the participants associated with that case being allowed to access and contribute to the conference, while the other cases would be designated as “inactive,” with the participants associated with those cases being excluded from the conference (e.g., by having their video feeds, if any, disabled; having their audio channels, if any muted; etc). Then, when the judge wanted to switch from one case to another, the case which had previously been designated as “active” could be switched to “inactive,” the next case on the calendar could be switched from “inactive” to “active,” and all of the participants associated with those cases could have their statuses of being able to participate in, or being excluded from, the conference changed en mass. FIGS. 8 and 10-12, discussed below, depict interfaces showing the impact of switching between different cases scheduled for a single day might have on judge and attorney participants in a remote conference supported with the disclosed technology.

Turning now to FIG. 8, that figure shows an example interface which could be presented to a judge. This example interface has a schedule area (800) where scheduled cases can be listed showing, for example, scheduled time, case number, name of case, and type of case. Also shown is a virtual courtroom (802) that can visually represent active participants to the conference (the virtual courtroom (802) does not show any active participants in FIG. 8, because there is no active case currently, as shown by the case status indicator (804) and as might be the case when the judge has first joined the conference, but is not yet ready to begin proceedings). Also shown is a personal status indicator (806) that indicates whether the participant can be seen or heard, which, in the case of a judge participant will preferably by default indicate that the judge can be both seen and heard in, and can have access to, the remote conference.

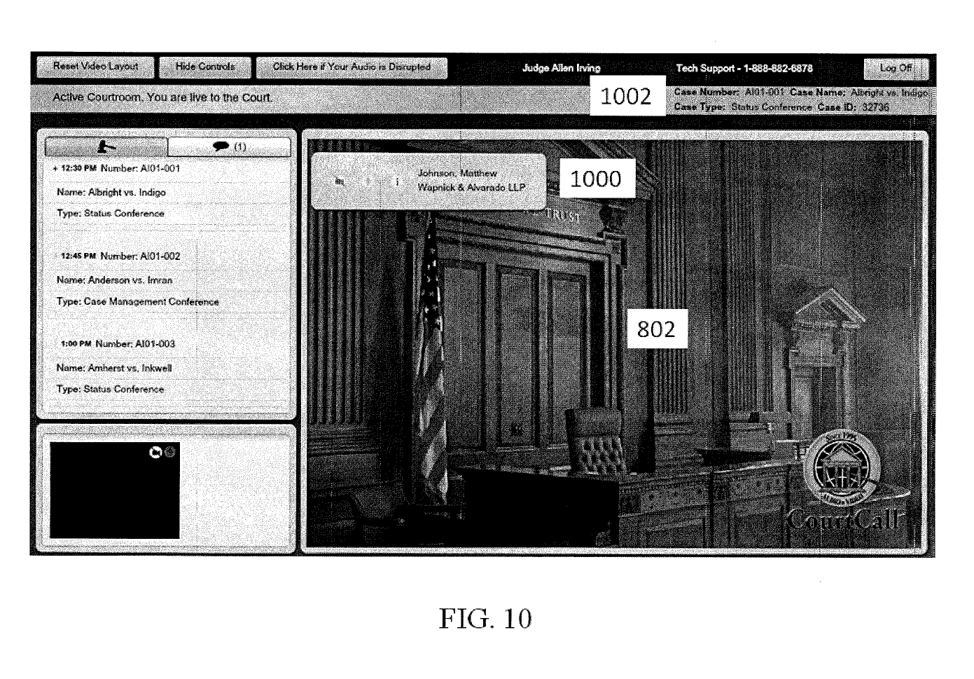

Turning now to FIG. 10, that figure shows an example interface of the type depicted in FIG. 8 which has been modified to indicate that one of the cases for the day has been changed from “inactive” to “active.” In that interface, the virtual courtroom (802) now shows a visual representation of an attorney participant (1000) who is associated with the active case. As shown in FIG. 10, such a representation (1000) may include various information about the participant, including the participant's name, law firm, party he or she is representing, ability to contribute to the conference (which, in FIG. 10, shows that hypothetical attorney Matthew Johnson's video feed has been disabled and his audio feed has been muted) or other information. Also, in the interface of FIG. 10, the case status indicator (1002) has been modified to reflect that a case is “active” by showing information relating to that case.

Variations on the interface of FIG. 10 are also possible, and will be immediately apparent to, and could be implemented without undue experimentation by, those of ordinary skill in the art in light of this disclosure. For example, while the virtual courtroom of FIG. 10 includes only a visual representation (1000) of a single attorney participant associated with the “active” case, it is possible that a virtual courtroom could include representation(s) of one or more other attorney participants (e.g., attorneys for the other party or parties in the “active” case), or of the judge himself or herself. Depending on the implementation, these visual representations could be identical to that depicted in FIG. 10, but they could also differ in various manners. For example, while the visual representation (1000) in FIG. 10 indicates that the corresponding attorney participant's video input is not enabled, it is possible that other visual representations might include video feeds showing images or video captured by the relevant participant (e.g., via a desktop webcam). Similarly, it is possible that different visual representations could have different appearances depending on the participants they were presented to. For example, in an interface presented to a judge, the portions of a visual representation for an attorney participant indicating whether that participant's input(s) to the conference were enabled could be displayed in a manner indicating that they could not be altered (e.g., being grayed out). However, those same portions of the visual representation of the judge could be displayed in a manner which would reflect that the judge could control his or her inputs as he or she saw fit (e.g., by muting his or her audio, or cutting of his or her video). Accordingly, the discussion about should be understood as being illustrative only, and should not be treated as limiting.

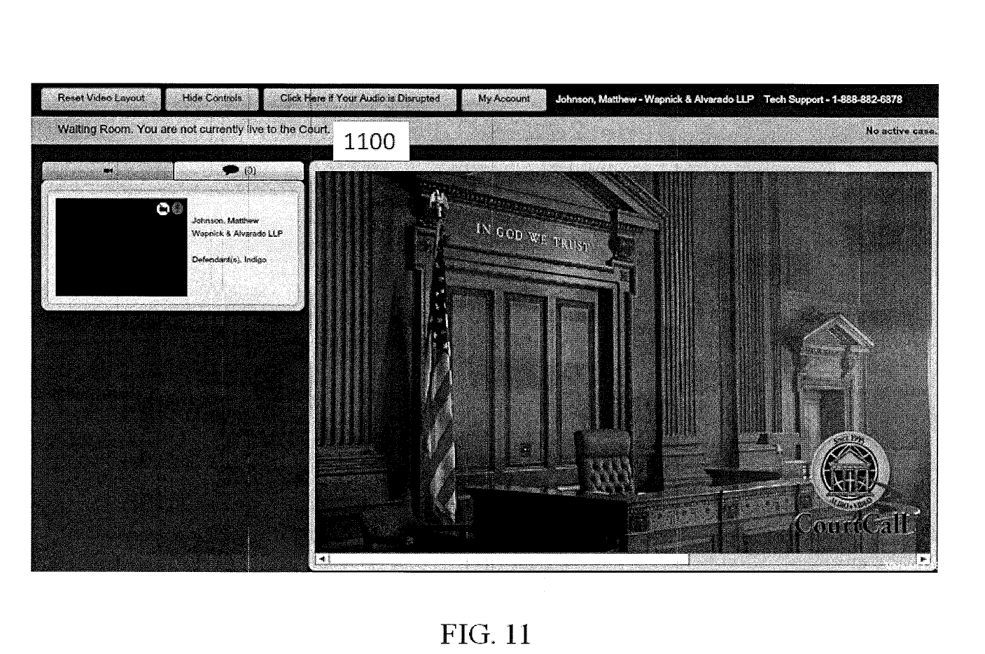

Turning now to FIG. 11, that figure shows an example interface from the perspective of an attorney participant who is not associated with an “active” case. In the interface of FIG. 11, this inactive status if reflected in the personal status indicator (1100), which indicates that the attorney is in a “Waiting Room,” which could be implemented by simply turning off the participant's inputs and outputs as described previously, or in other manners, such as by putting the participant into a subconference isolated from the conference where the “active” case is being handled. However it is implemented, this “Waiting Room,” in which a participant is connected to, but cannot access or contribute to, a conference, serves the useful purpose of allowing all participants to be available and to appear immediately if needed (e.g., if their case becomes “active” earlier than expected, such as due to a schedule change or an earlier case being resolved more quickly than anticipated).

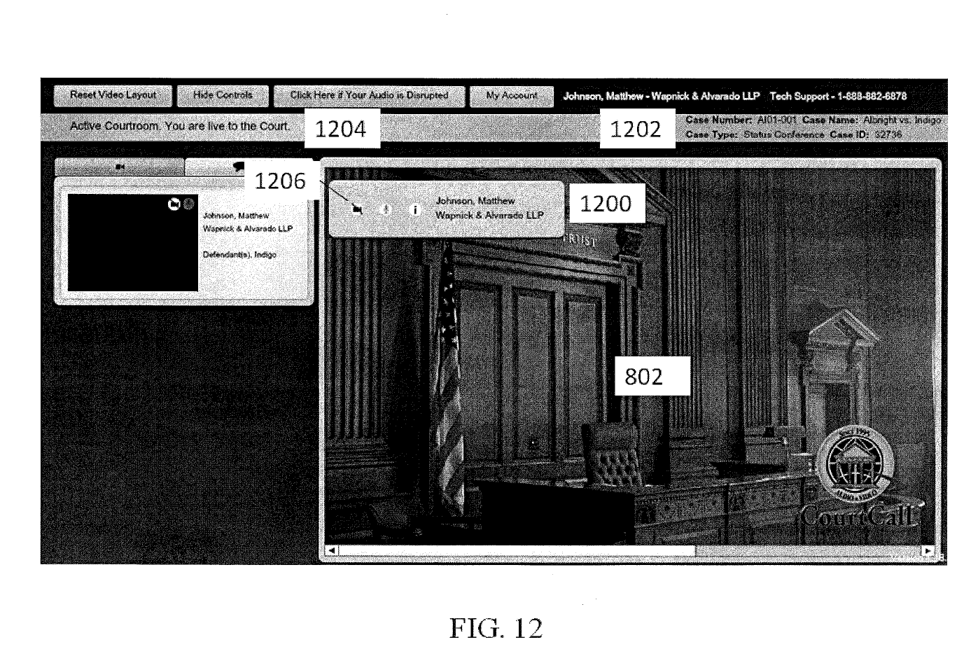

Turning now to FIG. 12, that figure shows an interface of the type depicted in FIG. 11 after the attorney participant's case becomes “active.” In the interface of FIG. 12, this change to “active” status is reflected in the fact that the virtual courtroom (802) now has a visual representation (1200) of the active participants to the conference which is similar to the representation (1000) shown in FIG. 10 (though because the visual representation in FIG. 12 is of the same participant the interface would be presented to, this visual representation, unlike the representation of FIG. 10, will preferably allow the participant to change the status of his or her input(s) to the conference). The change to “active” status is also reflected in the case status indicator (1202) and personal status indicator (1204), which, in FIG. 12, show information relating to the “active” case, have been updated to indicate that the participant is “live to the Court” (e.g., can access the conference where the “active” case is being handled).

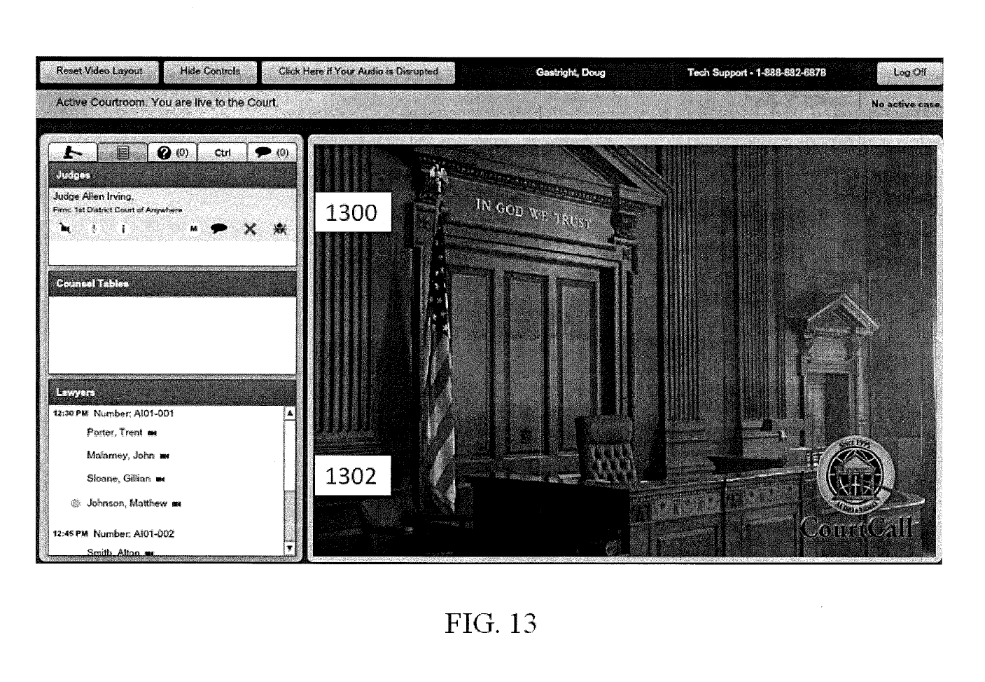

While FIGS. 8 and 10-12 depicted how changes between cases could impact attorney and judge participants in a conference supported with the disclosed technology, it should be understood that the technology described herein could be implemented in such a way as to support, even in a courtroom context, other roles for a conference. As an example of another role which could be supported in some implementations, consider the role of moderator, which could be filled by an individual who would handle administrative tasks without necessarily being associated with any scheduled case (e.g., an employee of a third party service provider). For example, in a situation where a judge has a low level of comfort operating interfaces such as could be presented by a system implemented using the disclosed technology, a moderator could listen in on a conference and perform tasks such as switching from one case to another as appropriate (e.g., when the judge says he or she would like to move from a first to a second case). A moderator could also perform various similar tasks (e.g., muting or unmuting individual participants), and provide general support for a conference's participants (e.g., could help participants resolve difficulties they may have in connecting to the conference, such as through chat functionality or though a dedicated extra-conference support line). FIGS. 13-15, discussed below, illustrate various interfaces which might be presented to and used by a moderator in implementations of the disclosed technology in which a moderator role is supported.

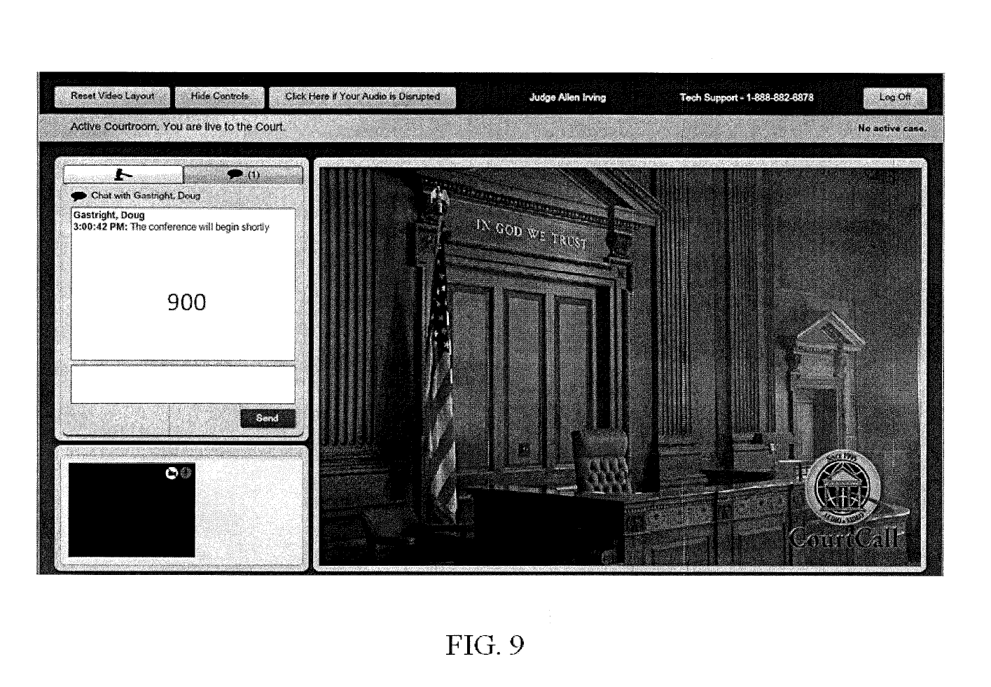

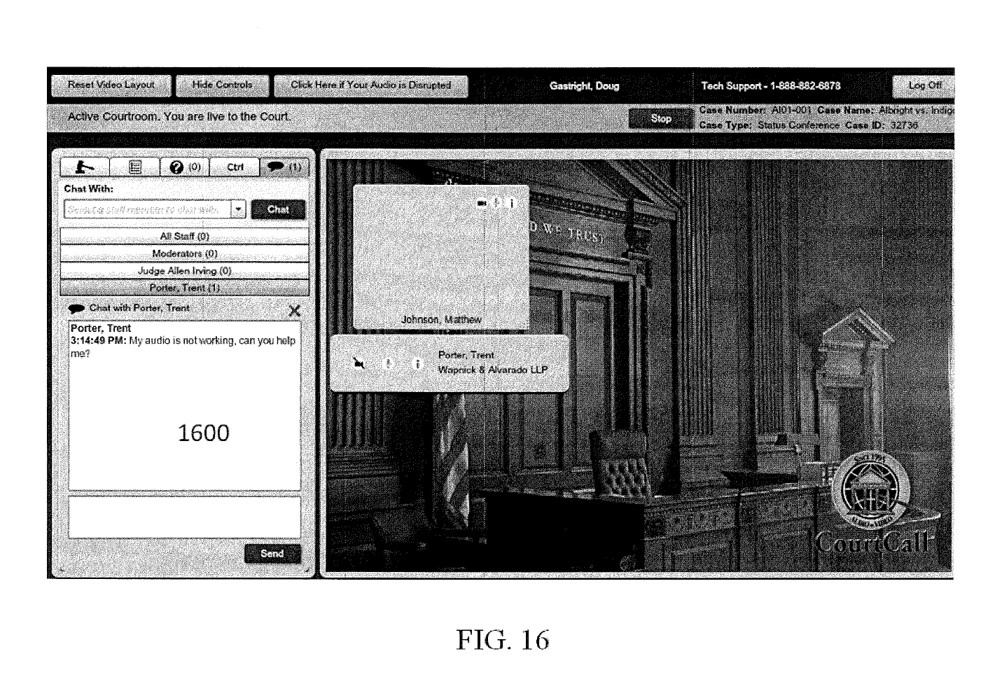

Turning now to FIG. 13, that figure shows an example interface which could be presented to a moderator when no scheduled cases are “active.” As shown in FIG. 13, such a moderator interface can include additional controls not available in the interfaces described above in the context of the judge and attorney participants. For example, FIG. 13 includes a judge status window (1300), which includes information about the judge who will handle the cases during the conference, as well as controls which could allow the moderator to enable or disable the judge's inputs to the conference, or to perform other actions directed specifically to the judge (e.g., initiate a chat session, discussed in more detail below in the context of FIGS. 9 and 16). The interface of FIG. 13 also includes a schedule status window (1302), which provides information relating to the participants associated with some or all of the scheduled sessions/cases, such as the time and case number each participant is scheduled for, whether the participant is currently connected/logged in (e.g., as shown by the dot by “Jason Matthews” in FIG. 13), and whether the participant's audio and/or video are enabled.

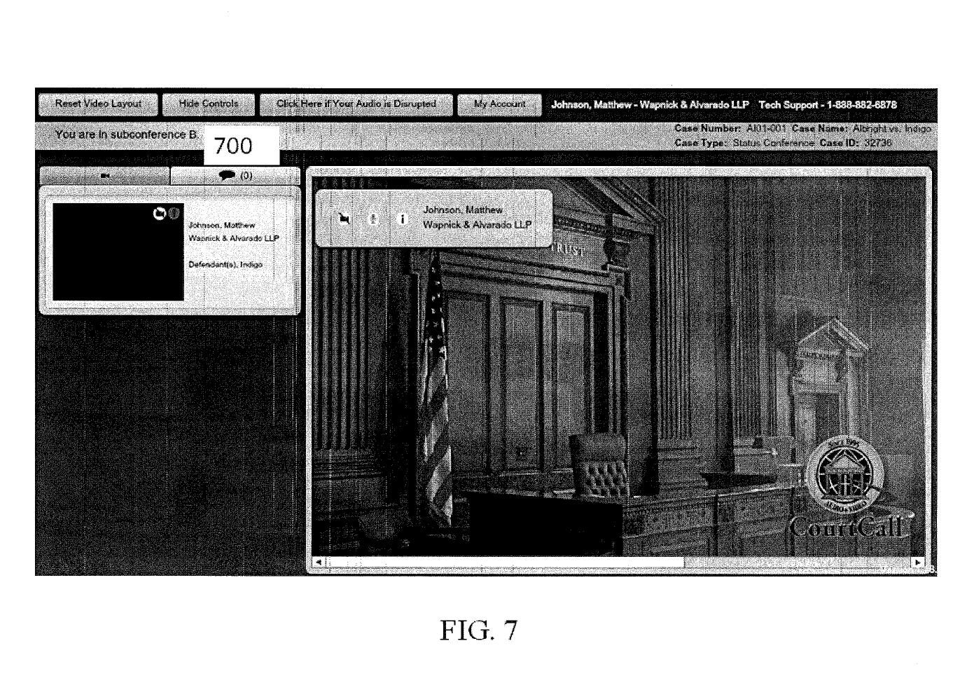

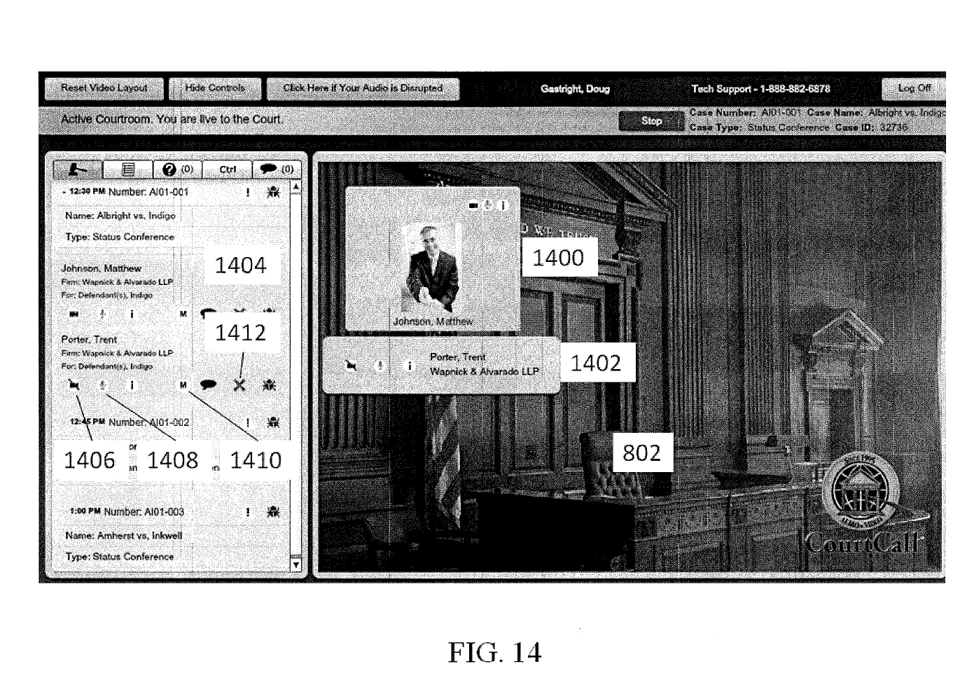

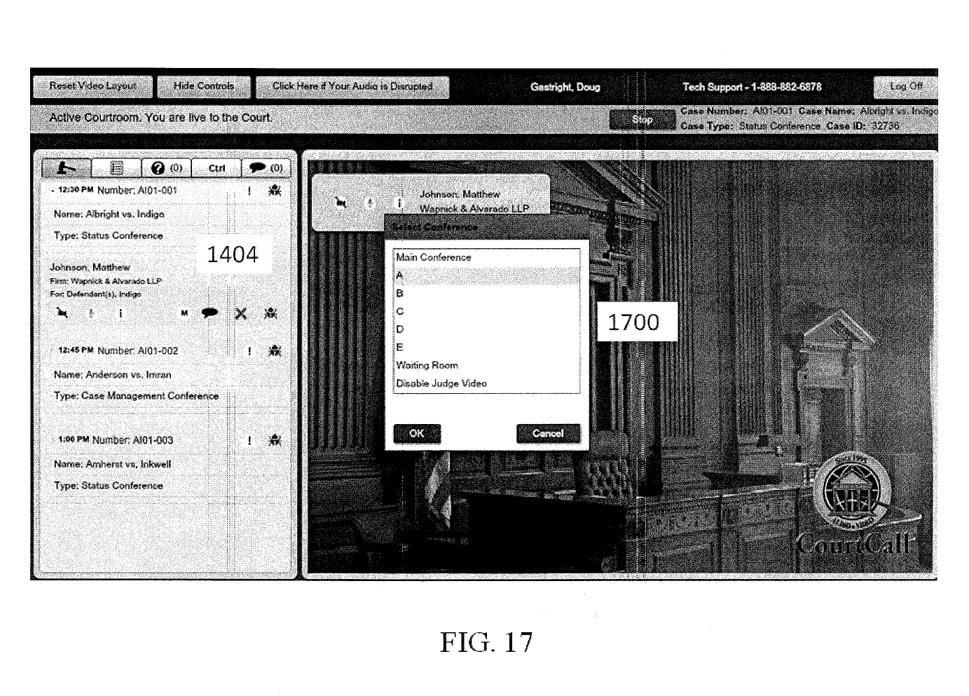

Turning now to FIG. 14, that figure shows an interface of the type depicted in FIG. 13 once a scheduled case has become “active. In the example of FIG. 14, one participant has video enabled so that a video feed is provided with that participant's visual representation (1400) within the virtual courtroom (802). A second participant does not have video enabled and instead has the simplified information only visual representation (1402) in the virtual courtroom (802). The interface of FIG. 14 also provides a case management window (1404) where each participant associated with the “active” case is listed, along with one or more controls allowing a moderator to enable or disable audio (1408) and video (1406) for that participant, move the participant into a subconference (1410) (discussed in more detail below in the context of FIGS. 17 and 7), remove the participant from the conference entirely (1412), and other controls.

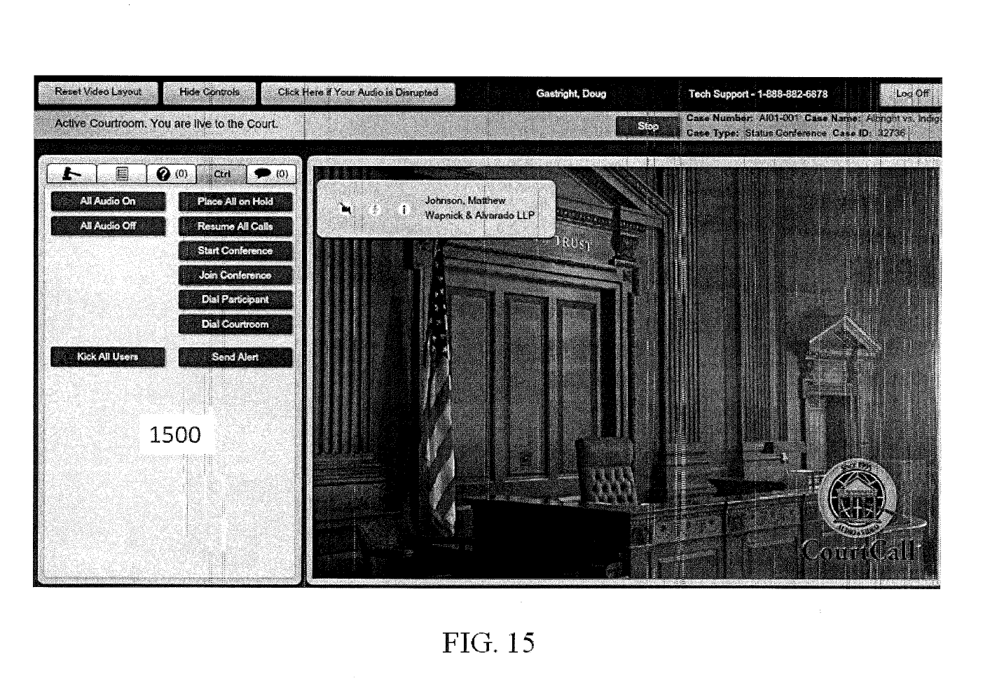

Turning now to FIG. 15, that figure shows another example of an interface which could be presented to a moderator when a case is “active.” However, while the interfaces of FIGS. 14 and 15 both could be presented to a moderator while a case is “active,” the interface of FIG. 15 differs from that of FIG. 14 in that it shows a control view (1500) which provides controls which would impact all users (e.g., turning off all users' audio inputs) rather than only impacting individual users (e.g., if the moderator turned off an individual user's audio input) or only impacting users associated with particular cases (e.g., changing the case which is currently considered “active,” such as by selecting a representation of a currently inactive case in a schedule window). The control view (1500) also includes tools which would allow the moderator to perform administrative functions in a manner which would not distract from other interactions which might be taking place. For example, the control view (1500) includes a control to allow the moderator to dial (i.e., place an outgoing call to) a participant or the courtroom, which could be useful in the event that the judge or an attorney has failed to join the conference, or has disconnected unexpectedly and not rejoined within a reasonable time. Other controls (e.g., allowing the moderator to add a new participant to a case, such as might be useful to accommodate schedule changes for the relevant attorneys) could also be included, and will be immediately apparent to those of ordinary skill in the art in light of this disclosure. Accordingly, the discussion above, like that which preceded it, should be understood as being illustrative only, and should not be treated as limiting.

Just as a moderator role could be included in some implementations as an addition to the roles for conference participants, it is possible that, in addition to communications which would be received by all participants associated with an “active” case, there could be support provided for communications targeted to individual participants or groups of participants other than those associated with a case which is “active.” For example, it is possible that a system implemented using the disclosed technology to support a conference where cases are handled using audio and video streams could allow users to send text messages which could be targeted to other users or groups of users who may or may not be associated with an “active” case. Illustrations of interfaces which could be provided to support this type of functionality are provided in FIGS. 9 and 16. In those figures, FIG. 9 depicts an interface similar to that depicted in FIG. 8 after it has been switched from displaying the schedule area (800) to displaying a chat area (900). This type of chat area (900) could allow a judge or other type of participant to enter a text communication which would automatically be sent to a moderator (or other staff, depending on the implementation), thereby providing a side-channel the participant could use to address administrative or technical issues which would not interrupt the handling of the “active” case. FIG. 16 shows an interface which, like the interface of FIG. 9, provides chat functionality but which, rather than being provided to a participant, would be provided to a moderator, and could allow him or her to engage in side-channel communications with individual participants, groups of participants, other moderators, or other staff for the conference.

Of course, in implementations of the disclosed technology which provide support for communicating in a manner which does not distract from the handling of an “active” case, such communications are not required to be supported via chat functionality such as described above. For example, as an alternative to (or in addition to) chat functionality as described in the context of FIGS. 9 and 16, the disclosed technology could be implemented to support separating out individual participants into subconferences where they would be able to communicate over the same communication channels as would be used to handle the “active” case (e.g., audio and video streams), but could do so in a virtual setting which would be isolated from the other participants who had not been assigned to the subconference (i.e., those other participants, including those handling the “active” case or assigned to other subconferences, would not be able to access or contribute to the communications between the participants in the subconference, and the participants in the subconference would not be able to access or contribute to the communications of the participants handling the “active” case or of the participants assigned to other subconferences). This type of subconferencing could be useful, for example, if a judge believes that an “active” case has reached a point where the participants associated with that case might be able to work their disagreements out amongst themselves in which case the judge could ask the moderator to move those participants to a subconference, and change the next case to “active” so that that case could be handled while the participants in the subconference interacted privately.

FIGS. 17 and 7 illustrate interfaces which could be used to support subconference functionality such as described above. In those figures, FIG. 17 shows an interface which could be presented to a moderator after he or she has selected an option from the case management window (1404) of the type shown in FIG. 14 to move a participant into a subconference. As shown in FIG. 17, this type of movement to a subconference can be achieved using a subconference management window (1700) which lists one or more subconferences a participant could be placed in (potentially including subconferences with participants associated with other cases, if such placement is appropriate in a given situation), and could also be used to move the participant to a “Waiting Room” as described previously, or to place him or her into the “main conference” (i.e., allow the participant to access and contribute to the interactions taking place in the context of handling the “active” case). FIG. 7 shows an interface which could be presented to an attorney participant after he or she has been moved into a subconference (which, in the example of FIG. 7, is subconference B). This movement is reflected in the interface of FIG. 7 in the participant's personal status indicator (700), which indicates that the attorney participant has been moved into subconference B, meaning that the participant's audio, video, and chat is now only available to other participants that have also been moved into subconference B.

Of course, it should be understood that the above discussion and accompanying figures are intended to be illustrative only, and that variations from what is described and depicted above are possible, even in implementations of the disclosed technology which are intended for a courtroom setting. For example, it is possible that the permissions necessary to perform various acts could be allocated among the various roles differently than described above (e.g., authority to perform some or all of the acts described above in the context of the moderator, such as switching between cases, could be shared with, or allocated solely to, a judge). Similarly, it is possible that the disclosed technology could be implemented in a manner which omits one or more of the roles described above (e.g., omission of the moderator, in a case where one or more other participants had the ability to perform the tasks necessary to manage the conference).

It is also possible that, rather than (or in addition to) removing roles, additional roles could be added. For example, rather than simply including “attorney participants” there could be different categories for different participants who might (or might not) be associated with the parties to a case. These roles could include fact witness, expert witnesses, first and second chair attorneys, paralegals, and other support staff. Where such additional roles are present, they could not only be handled differently by the system (e.g., when a case is “active,” preferably only representations of the first chair attorneys for that case would be added to the virtual courtroom), but could also be accommodated by modifications to the overall structure of the interfaces presented to the users. For example, a separate portion of the interface could be devoted to a “virtual counsel table” where visual representations of second chair attorneys representing a party to an active case could be displayed. To further enhance the similarity between a real counsel table and a “virtual counsel table,” second chair attorneys could be provided access to an audio-only subconference which only they would be able to access or contribute to (potentially in addition to allowing them to access, but not contribute to, the main conference where the “active” case is being handled) and/or be provided with the ability to send chat messages to their first chair attorney (i.e., in a manner similar to the passing of notes between co-counsel which takes place in physical courtrooms now). Other modifications are also possible (e.g., adding a “virtual witness box” in which video streams of various witnesses who may not be present in a physical courtroom could be displayed as those witnesses provided their testimony) and will be immediately apparent to those of ordinary skill in the art in light of this disclosure. Accordingly, the discussion of variations, like the discussion and figures which preceded it, should be understood as being illustrative only, and should not be treated as implying limitations on the protection provided by this document or any related document.

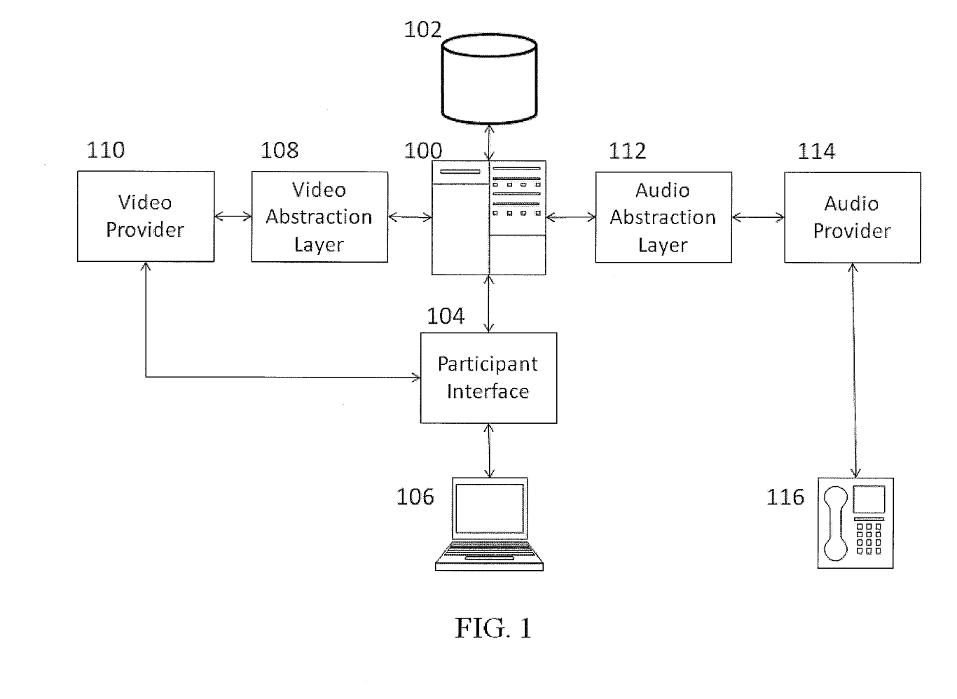

Turning now to infrastructure and algorithms which could be used in implementing the inventors' technology, FIG. 1 shows a schematic diagram of an exemplary system configured to manage a remote conference such as described above. In this example, a management server (100) is communicatively coupled with a database (102) so that each can send information to and receive information from (e.g., the cases various participants are associated with, whether the participants have been placed into a subconference, whether they have been muted, etc) the other. The management server (100) can be implemented as one or more physical servers, virtual servers, computers, laptops, or other processing devices. Similarly, the database (102) can be implemented as one or more relational databases, distributed databases, flat file database, or other storage method.

In the schematic diagram of FIG. 1, the management server (100) is also in communication with an audio provider (114) via an audio abstraction layer (112). The audio provider (114) may be a separate system or a third party service that provides audio conference capabilities via, for example, telephone or voice over IP. An audio provider (114) can be any of a number of commercially available teleconference providers, and may be dialed into by one or more participants via a device (116) that supports telephone or voice over IP to provide a teleconference session. The audio abstraction layer (112) (which will preferably be implemented as a software service hosted by the management server) facilitates communication between the management server (100) and the audio provider (114) by translating commands from the management server (e.g., mute participant, move participant to subconference, etc) into the format (or formats, in the case of an implementation where a management server (100) might be required to interact with multiple audio providers (114)) required by the audio provider (114). This can be useful, for example, when different individuals of entities (e.g., different judges) which would run remote conferences using a system such as shown in FIG. 1 might have existing relationships with their own providers, as an abstraction layer (112) of the type shown in FIG. 1 would allow the management server (100) to interact with each of those providers without requiring any changes to its internal programming.

In the schematic diagram of FIG. 1, the management server (100) is also in communication with a video provider (110) via a video abstraction layer (108) similar to the audio abstraction layer (112) described previously. As with the audio provider (114), the video provider (110) may be a separate system or a third party service that provides video conference capabilities via, for example, an internet connection, a wireless network, a radio transmission, or other communication, and an implementation following FIG. 1 may include one or more video providers (110) with which the management server (100) could communicate via the video abstraction layer (108). Video conference capabilities may include video alone, or video and paired audio. Where video capabilities include paired audio it will generally be disabled, but may be enabled (e.g., by a moderator, or automatically in the event the management server (100) detects that such enabling would be necessary to maintain audio for the relevant participant) in the event that audio conference capabilities from the audio provider (114) are interrupted or unavailable. Of course, it should be understood that, while the video (110) and audio (114) providers are depicted as separate from both each other and from the management server (100) in FIG. 1, it is possible that the disclosed technology could be implemented in a system where the functionality of the video provider (110), the audio provider (114), or both, are provided by the management server (100) rather than by separate systems. In such a case, it may be that the abstraction layer(s) for the service or services which would be provided by the management server (100) would be omitted, though they could also be maintained, for example, to enable easier integration with third party service providers as the need arises.

In addition to the back end components described above, the diagram of FIG. 1 also depicts an interface (104) (often referred to herein as a “participant interface,” though it could be presented to users with roles that do not correspond to direct participation in a conference, such as moderators) representing interfaces which could be provided to the various users, such as those illustrated in FIGS. 7-17. In implementations following the schematic diagram of FIG. 1, the participant interface (104) will preferably be implemented as a web based interface accessible via a web browser on a participant device (106). The participant interface (104) can be built using one or more client side languages such as HTML, JavaScript, Flash, Flex, or other programming technologies. The participant interface (104) can accept inputs from a participant device (106) and communicate them to the management server (100). Inputs communicated to the management server (100) can effect changes in the system by causing execution of one or more server side instructions, such as could have been encoded using languages such as Java, PHP, C++, or other programming technologies. In this manner, an input from a participant device (106) may be received by a participant interface (104), communicated to the management server (100), and processed to cause a command to be sent to the audio provider (114) or video provider (110) via the appropriate abstraction layer and API. Additionally, in some cases, input from a participant interface (104) could be handled directly by the management server (100) itself (e.g., a chat message sent via the participant interface (104) could be propagated to the participant interface (104) of the appropriate target by the management server (100) without interaction with the audio (114) or video (110) providers). Inputs from the participant accepted by the participant interface (104) could include, for example, connection to the conference, disconnection from the conference, muting of a participant, removal of a participant from the conference, and other inputs that will be described in further detail below.

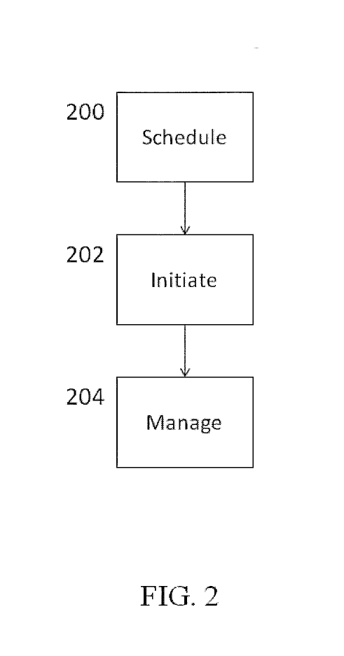

Turning now to FIG. 2, that figure shows a flowchart of a set of high-level steps that could be performed to manage a remote conference. A conference can be scheduled (200) so that characteristics such as time, date, topic, participants, and audio or video capabilities can be defined or enabled and then communicated to conference participants via, for example, email or text message. When a scheduled (200) conference time and date arrives, the conference can be initiated (202) by allowing participants to connect to the participant interface (104) and provide the details of the particular conference they are connecting to. Details provided could include one or more of username, password, personal identification number, case number, or other identifiers. Once connected to the participant interface (104), instructions may be provided to allow the participant to connect to the appropriate audio provider (114) and/or video provider (110). Connection with an audio provider may vary by embodiment, but could include providing a phone number that the audio provider (114) can use to call the participant, providing a phone number that the participant can use to call the audio provider (114), or additionally providing a personal identification number or case number that could be entered by phone. During a conference, as discussed previously in the context of FIGS. 7-17, the participant interface (104) provides functions and controls that allow connected participants to manage (204) aspects of the conference based upon their roles.

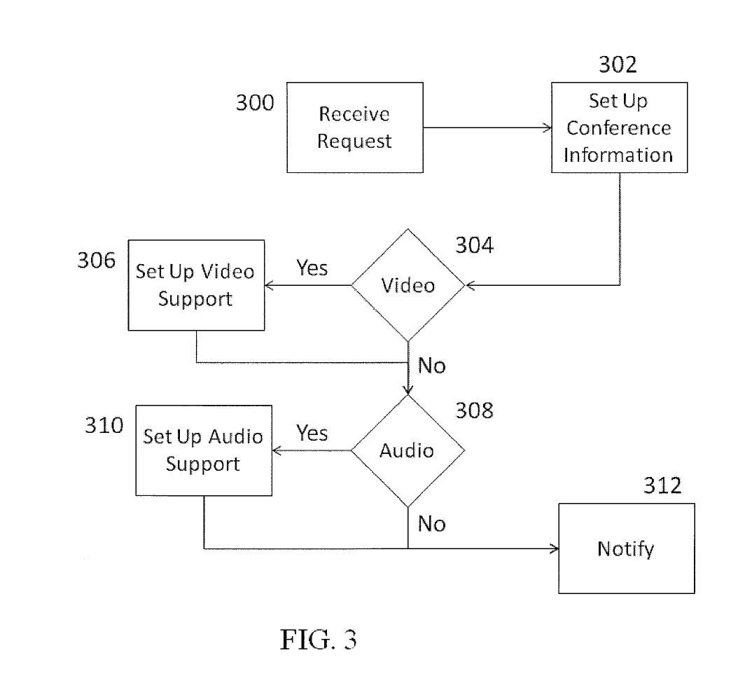

Turning now to FIG. 3, that figure shows a set of steps that could be performed in an implementation following the schematic diagram of FIG. 1 to schedule a remote conference. The method of FIG. 3 begins with the receipt (300) of a conference request. Such a request could potentially be submitted to the management server (100) via, for example, an interface provided by the management server (100), a web submission form, phone submission, or email submission. Alternatively, in some implementations a request such as would be received (300) in the method of FIG. 3 could be automatically generated, such as by a process which automatically requests appropriate conferences to handle upcoming cases on a court's docket. However, it is provided, a request such as would be received (300) in the method of FIG. 3 will preferably contain one or more pieces of information relating to the requested conference, such as date, time, topics, topic participants, participant roles, a need for audio capabilities, or a need for video capabilities.

TABLE 1
Example JSON data structure for courtroom style
conference request submitted via web form

{

“conference”: {

“conftype” : “courtroom”
“courtid” : “123456789”,
“date”: “7/3/2014”,
“video” : “true”,
“videoproviderid” : “12345”,
“audio” : “true”,
“audioproviderid”: “12345”,
“case” : {

“time”: “12:30”,
“type”: “status conference”,
“caseid”: “AI01-001”,
“casename”: “Albright vs. Indigo”,
“participant”:{

“name”: “Johnson, Mathew”,
“participanttype”: “attorney”,

}
“participant”:{

“name”: “Porter, Trent”,
“participanttype”: “attorney”,

}

}
“case”: {

“time”: “13:30”,
“type”: “case management conference”,
“caseid”: “AI01-002”,
“casename”: “Anderson vs. Imran”,
“participant”:{

“name”: “Smith, Alton”,
“participanttype”: “attorney”,

}
“participant”:{

“name”: “Chalmers, Wendy”,
“participanttype”: “attorney”,

}

}

}

}

Once the request is received (300), the method of FIG. 3 continues with setting up the conference information by writing data to a memory (e.g., in a database such as shown in FIG. 1). As discussed previously, a conference may have one or more sessions, with each session having different topics and participants. As an example, a conference within a courtroom setting might have multiple sessions, with each session being a different case that is to be heard before a judge, and each case having its own list of participating attorneys. The management server (100) can create and save to its database (102) data structures representing each session of the conference.

This conference set up can also include storing information for the conference's participants, such as by creating and saving data structures representing each participant within each session. In some embodiments, participants may be submitted and created based entirely upon the request (300), but in others participants may already be fully or partially configured within the system such that a unique participant ID can be specified in the request and used to look up stored information instead of requiring the request itself to submit a full set of information for each participant. Information that could be stored or submitted for each participant could include the participant's name, company, contact information such as telephone number, email address, other identifiers such as a state bar identification number or driver's license number, or other information. Once submitted and stored, such information could be associated with a unique identifier such as a username, personal identification number, or email address so that future requests could identify the previously submitted information of a participant by the unique identifier rather than re-submitting the entire set of information.

After being set up, participants can be linked within the database (102) to sessions so that the management server (100) may identify the participants that should be active for a session by a database query against the tables describing such a link. Similarly, configured sessions may be linked to a conference and may be identified by database query against tables describing such a link.

In implementations following FIG. 3, after configuration (302) of the sessions and participants, the depicted process will continue with the management server identifying (304) whether video support is needed. If video support is needed for the requested conference, the management server (100) may set up video support (306) for the conference. In embodiments where a third party video provider is used, this may include sending an external request to the third party video provider providing details of the conference. Next, the management server (100) will check (308) if audio support is required for the requested conference, and, if it is, will set up audio support (310) for the conference. As with cases where a third party video provider is used, for a conference where a third party audio provider is to be used, this may include sending a request to the third party audio provider providing details of the conference.

In some embodiments where a third party audio or video provider is used, the management server (100) may save details of the particular third party provider that is to be used. Such details could include an identifier such as a web service address, URL, or IP address that may be used by the video abstraction layer (108) to communicate with a defined provider. A preference for a particular provider may be contained within a request (300), may be associated with the source of a request (300), or may be chosen by default. In this manner, when a conference is requested by a scheduler that may have a geographical or contractual preference for a particular audio or video provider, that provider can be specified within the request. Alternately, a record may be created within the database (102) associating a scheduler with their preferred provider. If no provider is specified at the time of request or associated within the database (102), a default provider may be chosen based upon criteria such as cost, reliability, or geographic proximity.

Finally, the method of FIG. 3 concludes with the management server (100) generating one or more alerts, such as emails, text messages, or phone calls, notifying (312) each participant that the conference has been scheduled. Notifications may also include instructions for joining the conference via the participant interface (104) and/or phone (116) as well as any passwords or other unique identifiers that the participants would provide to identify and/or authenticate themselves and/or the conferences they would join.

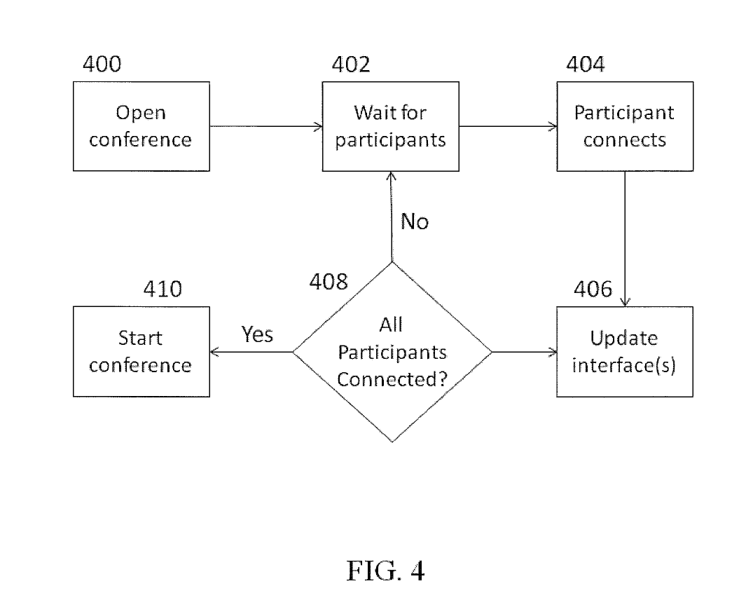

Turning now to FIG. 4, that figure shows a set of steps that could be performed to start a remote conference supported by a system implemented in a manner following the schematic of FIG. 1. In the method of FIG. 4, when the time for a scheduled conference arrives, the conference is opened (400) and the management server (100) begins to wait (402) for connecting participants. Then, as the each participant connects (404), the management server (100) can update (406) the interface presented to that participant, as well as updating interfaces presented to other participants who have already connected (if any) to reflect the presence of the new. This can include, for example, determining the identity of the participants as they connect (404), such as by using a unique password, personal identification number, or information passed via URL provided by the participants, then looking up the roles for those participants in a database, and providing the participants interfaces based on the information retrieved from the database. After this, if it is determined (408) that all participants have connected, the conference can be started (410). Otherwise, the process can return to a waiting (402) state, and repeat as additional participants connect (404).

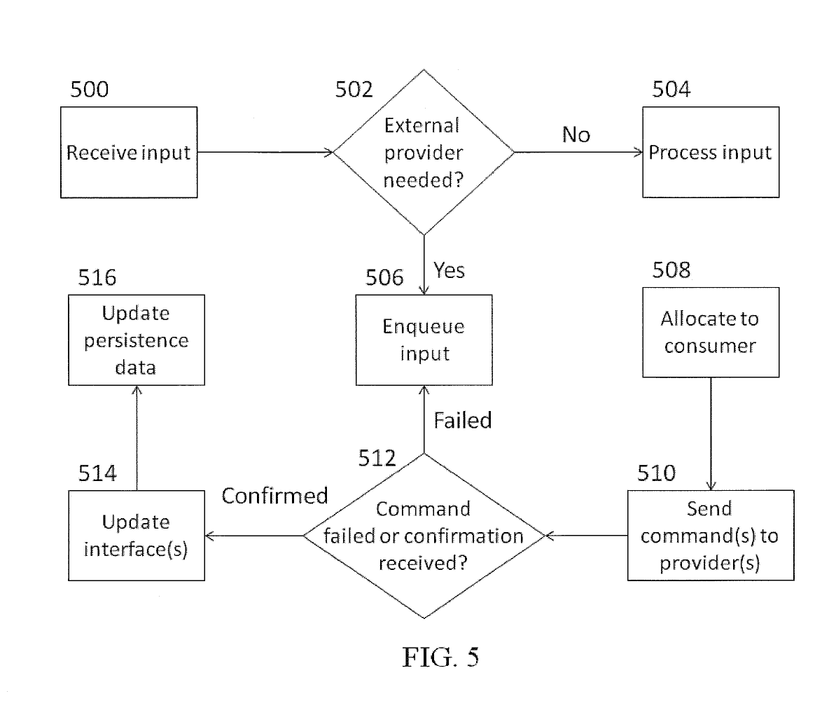

Variations on the steps depicted in FIG. 4 are also possible, and could be implemented using the disclosed technology. For example, while the discussion above treats a connection by a participant as being simply a connection between the participant and a management server, it is possible that connecting would involve other entities as well. To illustrate, consider the case where the disclosed technology is implemented in a system which includes a separate audio provider (114) as illustrated in FIG. 1. In such a case, a participant may connect (404) to the management server by clicking on a URL from, and entering login credentials provided in, a notification email provided when the conference was scheduled. He or she might then separately connect by calling the audio provider (114) using call in information which might be provided via the participant interface (104) after connecting to the management server (100), or which might also have been included in the notification email. In this type of approach, after the participant has connected to the audio provider (114), that provider might provide a confirmation message to the management server (100) notifying the management server that the participant had successfully connected (e.g., by providing the management server, via an abstraction layer, with a confirmation message including a personal identification number for the participant), at which point the management server (100) might, assuming it had not already been stored as part of setting up the conference, store information (e.g., an identification number) which could later be used to identify that participant to the audio service provider in the event action by the audio service provider with respect to that participant was required at some subsequent point (e.g., to implement a command received during the conference, as described in more detail in the context of FIG. 5, infra).

Of course, even when communication capabilities are provided by multiple entities, participants may not necessarily be required to perform separate connection steps as described above. To illustrate, consider a case where participants in a conference are allowed to engage in both audio and video interactions, and the video interactions are provided by a separate video provider (110). In this type of case, rather than requiring a participant to separately connect to the video provider (110), a management server (100) could, upon a connection being established by the participant, send a message to the participant interface (104) with an address for the video provider (110) that the participant interface (104) could use to download video information directly from the video provider (110) to the participant's device (106), which would then be displayed to the participant in the appropriate location in the participant interface based on instructions downloaded by the participant device (106) at the time it connected to the management server (100). Alternatively, when a participant connects to the management server (100), the management server (100) could establish a connection to the video provider, and act as a conduit between the video provider (110) and participant device (106) once the conference begins.

Turning now to FIG. 5, that figure shows a set of steps which could be performed by a system implemented according to the schematic diagram of FIG. 1 to process inputs from users, coordinate actions of external service providers (e.g., audio and video providers), and minimize disruptions which would be caused in the event that connection issues arise during a conference. The method of FIG. 5 starts with the receipt (500) by the management server (100) of an input entered via an interface (104) provided to a user. Once the input is received (500), the management server (100) would determine (502) if the input was something which should be implemented in coordination with an external service provider and, if it is not, will process (504) the input itself For example, if the input is a chat message to be sent from one user to another, the management server (100) will preferably be implemented to have the capability of simply updating the interface(s) of the intended recipient(s) with the chat message without requiring interaction with external providers who may be providing services in support of specific types of communications (e.g., video or audio providers). By contrast, as described below, other types of input, such as commands to mute a participant, may require action by an external provider to be implemented (e.g., if the participant had established a separate connection with an audio provider when connecting to the conference).

In the method of FIG. 5, if the implementation of an input would require coordination with an external provider, that input would be pushed into a queue for processing. This pushing of an input to a queue before processing or taking any action on it can allow the management server (100) to immediately receive further inputs, thereby preventing a bottleneck at the point of communication between the management server (100) and the external provider(s) that can result in lost or delayed communication of inputs. The queue to which an input can be pushed (506) can be implemented as a virtual queue such as RabbitMQ, Web Sphere MQ, Java Message Service Queue, or another implementation. Once pushed (506) to queue, the input may be stored there until a consumer process becomes available, at which point it may be allocated (508) to the consumer for processing (e.g., by popping the input from the queue, by leaving it in the queue but modifying data associated with the input to show that it has been allocated, etc).

After an input is allocated (508) to a consumer, processing of that event could begin with the consumer sending (510) one or more commands to the appropriate service provider(s). For example, if the input is a command from a moderator to mute a participant, the consumer could (preferably via an abstraction layer which would perform tasks such as identifying the specific information needed to identify the relevant participant and/or conference to the audio provider) send a command to the audio provider requesting that the participant be muted. Similar sequences of events could take place for other types of commands (e.g., remove a participant from a conference, move a participant to a subconference, add a participant to a conference, etc) which would impact a participant's ability to access or contribute to particular types of interactions supported by external service providers. Similarly, if an input would require actions by multiple service providers to be implemented (e.g., removing a participant from, or adding a participant to, a conference or subconference), then the consumer process could send the appropriate commands to each of the necessary providers.

After the consumer sends (510) the appropriate command(s) to the appropriate provider(s), it will preferably wait until it determines (512) that the command has failed (e.g., because no success confirmation is received within a timeout period) or a confirmation that the command has succeeded has been received. If the command failed, it will be made available (506) in the queue for processing, (e.g., by being added back to the queue if it was previously removed, by modifying data associated with the input to show that it can be allocated to a consumer, etc). Alternatively, if a confirmation that the command has succeeded is received (e.g., because it is sent by the appropriate service provider), the method of FIG. 5 will continue by updating (514) the interface of the participant impacted by the input and the interfaces presented to other participants as appropriate (e.g., if a participant is muted, then his or her interface could be updated to show the muted status, as could any other interfaces, such as those presented to a moderator, which would indicate the muted status of the participant).

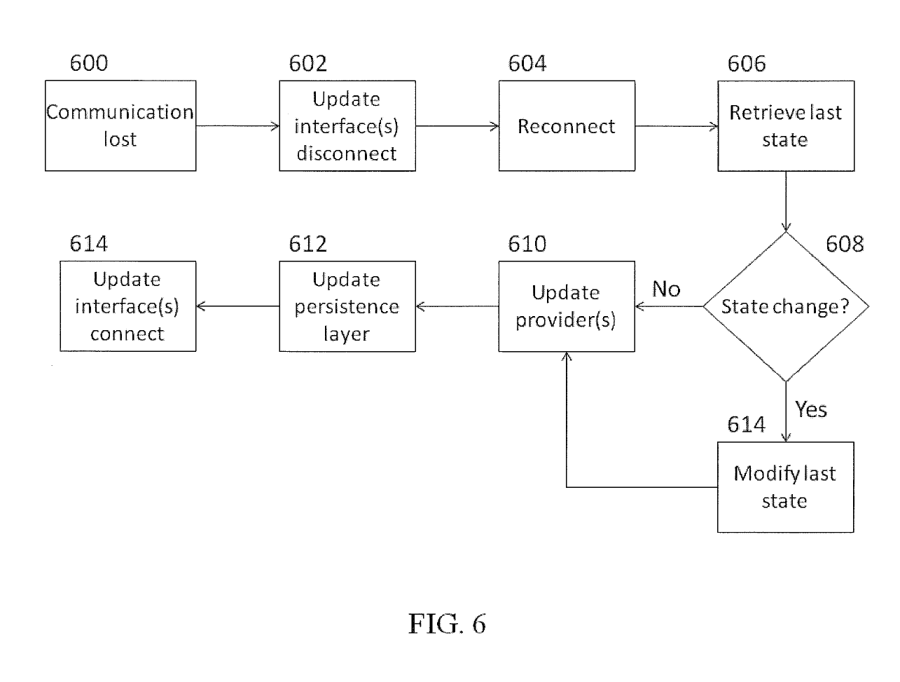

After a command has succeeded, in addition to updating (514) the appropriate interface(s), an implementation performing the method of FIG. 5 would also update (516) persistence data showing that the input had been implemented. This persistence data is data that could be stored in the management server (100) and/or database (102) that describes the status of a conference, its participants, and the various sessions and subconferences in the conference. This data can be useful, for example, to recreate the status of a participant who is inadvertently disconnected, ensuring that he or she is placed into the conference in the appropriate manner when he or she reconnects (e.g., if the participant was in a subconference when disconnected, he or she can be placed directly into that same subconference when he or she reconnects; if the participant was muted when disconnected, he or she can be automatically muted when he or she reconnects, etc). An exemplary method for how this could take place is illustrated in FIG. 6, below.

Turning now to FIG. 6, that figure shows a set of steps that could be performed in an implementation following the schematic diagram of FIG. 1 to manage reconnection of a disconnected participant. During a conference, a participant may suffer a loss (600) of communication with one or more of the participant interface (104), audio capabilities, or video capabilities. In such a case, the management server (100) may update (602) the interface(s) of other participants to reflect the loss of communication. In this way, other participants may be notified that the disconnected participant has lost the use of one or more of the participant interface (104), audio capabilities, or video capabilities. The management server may allow the disconnected participant to reconnect (604) so that the conference may continue. In the event of a loss of the participant interface (104), the disconnected participant could re-open the interface in the same manner as the initial connection to reconnect. In the event of a loss of audio capabilities, the disconnected participant could redial the provided conference number and reenter the provided identifying information to reconnect. In the event of a loss of the video capabilities, the disconnected participant could click the enable camera button (1206) to reconnect.

When a reconnection (604) is made, the management server (100) may retrieve from the persistence data a copy of the disconnected participant's last known state within the conference. The last known state data could include, for example, whether the participant's audio is enabled or disabled, whether the participant's video is enabled or disabled, which case was active, whether the participant was in the main conference or a subconference, whether the participant had exchanged chat messages with a moderator, or other state information. Once retrieved (606), the last state may be checked to determine if there has been a state change (608) that has occurred since disconnection. For example, an attorney participant may be connected and part of the active case, but may then lose communication with the participant interface (104). After the attorney participant loses communication, a moderator may stop the active case and switch to another case. Since the attorney participant is not in communication with the participant interface (104), the active case switch is not applied to the disconnected participant and there may be a mismatch between the disconnected participant's persistence data and their desired state. In such a case, the management server (100) may compare the active case identified in the participant's persistence data to the currently active case. If there is a mismatch indicating that the active case has changed since disconnection, the management server (100) may modify (614) the last state and apply the changes that would have occurred if the participant had been connected at the time of the case change. If there is no mismatch, then the active case did not change while the participant was disconnected and the last state from the persistence data may be used without change.

When a current state is available, whether it is an unmodified state from the persistence data or a state modified to reflect the desired status, the management server (100) may update (610) the provider(s) with the participant's state. Updating (610) the provider(s) may be performed via the abstraction layers (108, 112). Information sent when updating (610) the provider(s) may include some or all of the current state data. For example, if a participant is disconnected from the audio portion of the conference, upon reconnection the management server may send information from the current state such as whether the participant is muted or whether the participant is in the main conference or a subconference. In this manner, the audio provider (114) may place the reconnected participant into the appropriate conference or subconference and may ensure that the user is appropriate muted or not. When the providers have successfully updated the participant's status to reflect the current state within their systems, the management server (100) may update (612) the persistence data by saving the current state. The management server (100) may also update (614) the interface(s) of other participants to reflect that the disconnected participant has successfully reconnected and to apply any changes in the participant's state.

Another example of when a state change (608) determination might be made could be when a participant is disconnected from the participant interface (104) but maintains communication with the audio portion of the conference. While disconnected from the participant interface (104) the moderator might disable the participant's audio, causing the audio provider to mute the participant's audio portion. Upon reconnection (604) the last available state (606) from the persistence data might indicate that the participant is unmuted, whereas the audio provider may have the participant muted. The management server (100) may detect this state change (608) discrepancy by comparing the participants audio status according to the persistence data to the participants audio status according to the audio provider, which never lost connection and should represent the correct current state, and modify (614) the participants state to properly reflect the current state. In this scenario, no provider update (610) is necessary since the provider itself provided the correct current state.

Of course, it should be understood that the above discussion is intended to be illustrative only of how the disclosed technology could be implemented, and that variations on that disclosure are also possible and should not be excluded from the protection of this or any related document based on their not being explicitly included in the above disclosure. To illustrate, consider potential variations on the step of placing (506) an input into a queue discussed above in the context of FIG. 5. In some embodiments which follow the process depicted in that figure, there may be a single queue to which all inputs are pushed upon receipt, having one or more consumer processes that can handle any input type. In other embodiments, there may be a queue for each input type, with the management server (100) performing a preliminary examination of the input before choosing which queue to push it to, with one or more consumer processes optimized to handle a specific input type consuming from a specific queue. In other embodiments, there may be an initial queue to which all inputs are pushed upon receipt, with one or more consumer processes that pop inputs from the queue, examine them for their types, and then push them to an input specific queue, where input specific consumers may consume them. Similarly, in some implementations, rather than simply pushing an input to a queue, an enqueuing step (506) may include transforming the input into a corresponding data structure (e.g., an event, such as might be included in a queue used to implement an event driven programming paradigm), or multiple corresponding data structures (e.g., if an input would require actions by multiple providers to be implemented, then multiple events could be enqueued, with each event corresponding to one command for one service provider).

Other types of variations are also possible. To illustrate, consider variations on communication channels which could be used for interactions in a remote conference. In the above disclosure, the discussion of the inventors' technology focused on implementations three communication channels—text, audio and video—one of which (text) would preferably be handled internally by the same management server which would receive inputs submitted via the user interfaces, and the other two of which (audio and video) would potentially be provided by external service providers and coordinated by the management server. However, variations on this approach are also possible. For example, rather than requiring text interactions to be handled internally by a management server, the disclosed technology could be implemented so that all communication channels would be provided by external providers (e.g., text communications could be provided by an external instant messaging service provider), with the management server simply coordinating the external providers' actions.

Similarly, it is possible that different types of interaction channels could be supported using the disclosed technology. For example, text interactions could be supported by a chat room communication channel, either in addition to or alternative to the targeted text communications described above. There could also be redundant communication channels. For example, there could be a first text communication channel for interactions between participants about the subject matter of a conference, and a second text communication channel (which might differ in terms of reliability, latency, or other features) which could be used for technical support or other interactions which would allow the main conference to proceed.

Further variations on, features for, and applications of the inventors' technology will be apparent to, and could be practiced without undue experimentation by, those of ordinary skill in the art in light of this disclosure. Accordingly, the instead of limiting the protection accorded by this document, or by any related document, to the material explicitly described herein, the protection accorded by this document should be understood to be defined by the following claims, which are drafted to reflect the scope of sought when the terms in those claims which are listed below under the label “Explicit Definitions” are given the explicit definitions set forth herein, and the remaining terms are given their broadest reasonable interpretation as shown by a general purpose dictionary. To the extent that the interpretation which would be given to the claims based on the above disclosure is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary should control, and the inconsistent usage of terms in above description should have no effect.

### Explicit Definitions

When used in the claims, “access communications on a communication channel” should be understood to mean that the person or entity who can “access” has the ability to receive information communicated on that channel. For example, in a telephone conference, when a conference participant hears a statement over the conference's audio channel, the participant who heard the statement had “access to communications on the audio communication channel.”

When used in the claims, “based on” should be understood to mean that something is determined at least in part by the thing that it is indicated as being “based on.” For a claim to indicate that something must be completely determined based on something else, it will be described as being “based EXCLUSIVELY on” whatever it is completely determined by.

When used in the claims, “computer” should be understood to refer to a device or group of devices for storing and processing data, typically using a processor and computer readable medium. In the claims, the word “server” should be understood as being a synonym for “computer,” and the use of different words should be understood as intended to improve the readability of the claims, and not to imply that a “server” is not a “computer.” Similarly, the various adjectives preceding the words “server” and “computer” in the claims are intended to improve readability, and should not be treated as limitations. For example, the use of the phrases “management server,” “external server,” “user computer,” “representative computer,” and “moderator computer” is for the purpose of improving readability, and not for the purpose of implying a need for particular physical distinctions between those computers, or for those computers to be distinguished from one another in their operation (e.g., while a “moderator computer” could be used by a moderator hired specifically for the purpose of managing a remote conference, it could also be used by a participant in the remote conference, such as a judge).

When used in the claims “computer readable medium” should be understood to mean any object, substance, or combination of objects or substances, capable of storing data or instructions in a form in which they can be retrieved and/or processed by a device. A computer readable medium should not be limited to any particular type or organization, and should be understood to include distributed and decentralized systems however they are physically or logically disposed, as well as storage objects of systems which are located in a defined and/or circumscribed physical and/or logical space. A reference to a “computer readable medium” being “non-transitory” should be understood as being synonymous with a statement that the “computer readable medium” is “tangible”, and should be understood as excluding intangible transmission media, such as a vacuum through which a transient electromagnetic carrier could be transmitted. Examples of “tangible” or “non-transitory” “computer readable media” include random access memory (RAM), read only memory (ROM), hard drives and flash drives.

When used in the claims, “configure” should be understood to mean designing, adapting, or modifying a thing for a specific purpose. When used in the context of computers, “configuring” a computer will generally refer to providing that computer with specific data (which may include instructions) which can be used in performing the specific acts the computer is being “configured” to do. For example, installing Microsoft WORD on a computer “configures” that computer to function as a word processor, which it does using the instructions for Microsoft WORD in combination with other inputs, such as an operating system, and various peripherals (e.g., a keyboard, monitor, etc. . . . ).

When used in the claims, “contribute to communications on a communication channel” should be understood to mean that the person or entity who can “contribute” has the ability to provide information to one or more other people or entities via the communication channel For example, in a telephone conference, when a conference participant makes a statement which is heard by at least one other participant over the conference's audio channel, then the participant who made the statement “contributed to communications on the audio communication channel.”

When used in the claims, “data” should be understood to refer to information represented in a form which is capable of being processed, stored and/or transmitted.

When used in the claims, an “external permission modification” should be understood to refer to a change in the ability of a participant in a remote conference to access or contribute to a communication channel which is implemented through communications between a management server to which input is sent from an interface displayed on a computer associated with a participant in a conference and a separate server which is associated with the communication channel. For example, in a system such as claimed in claim 5, moving a participant into a subconference on the audio communication channel and preventing the participant from contributing to communications on the audio communication channel (e.g., muting him or her) would be “external permission modifications,” because they would be implemented by sending a requests to the audio server associated with the audio communication channel.

When used in the claims, “judge” should be understood to refer to an individual whose function is to resolve a dispute to which the “judge” is not a party. Examples of “judges” include judges appointed and confirmed according to article III of the U.S. constitution, mediators in an alternative dispute resolution context, and factfinders in an administrative context.

When used in the claims, “means for coordinating implementation of user requests with external servers” should be understood as a means+function limitation as provided for in 35 U.S.C. §112(f), in which the function is “coordinating implementation of user requests with external servers” and the corresponding structure is a computer configured to perform processes such as illustrated in FIG. 5, and discussed in paragraphs 55-59 and 64.

When used in the claims, “processor” should be understood to refer to a device or group of devices which is capable of performing one or more logical and/or physical operations on data to produce a result.

When used in the claims, “remote conference” should be understood to refer to an interaction in which not all participants are physically proximate to each other. An example of a “remote conference” is a conference call where all participants are located in separate locations and interact over a shared audio channel. Another example of a “remote conference” is a court proceeding in which a judge and a first attorney representing a first party are physically present in a courtroom, and a second attorney representing a second party is located in a separate location and interacts with the first attorney and the judge via audio and/or video channels.

When used in the claims, “representative” should be understood to refer to an individual acting for a person or entity in an interaction. Examples of “representatives” include attorneys appearing on behalf of a party to a lawsuit, and (e.g., in the case of an individual proceeding pro-se) a party to the lawsuit himself or herself.

When used in the claims, a “set” should be understood to refer to a number, group or combination of zero or more things of similar nature, design, or function.

1. A machine for managing a remote conference during which a plurality of cases are scheduled for meetings before a judge, the remote conference having a plurality of participants comprising the judge and one or more representatives for each case from the plurality of cases, the machine comprising:
a) a plurality of user computers;
b) a means for coordinating implementation of user requests with external servers; and
c) a set of external servers, wherein each server from the set of external servers:
i) is located remotely from the means for coordinating implementation of user requests with external servers; and
ii) is associated with an external communication channel;
wherein:
A) the means for coordinating implementation of user requests with external servers is configured to maintain data identifying a case from the plurality of cases as active;
B) at least one user computer from the plurality of user computers is configured to display an interface operable to submit a case change request indicating that a case from the plurality of cases should be designated as active;
C) the means for coordinating implementation of user requests with external servers is configured to, upon receiving the case change request, implement the case change request by performing acts comprising modifying the abilities of participants in the remote conference to contribute to communications with the judge, wherein modifying the abilities of participants in the remote conference to contribute to communications with the judge comprises:
I) preventing all representatives not associated with the case indicated in the case change request as the case which should be designated as active from contributing to communications with the judge on a first external communication channel associated with a first external server from the set of external servers; and
II) enabling all representatives associated with the case indicated in the case change request as the case which should be designated as active to contribute to communications with the judge on the first external communication channel.

2. (canceled)

3. A system for managing a remote conference during which a plurality of cases are scheduled for meetings before a judge, the remote conference having a plurality of participants comprising the judge and one or more representatives for each case from the plurality of cases, the system comprising:
a) a management server;
b) a plurality of user computers; and
wherein:
A) the plurality of user computers comprises:
i) a plurality of representative computers, wherein each representative computer is associated by data stored in a non-transitory computer readable medium with a representative associated with a case from the plurality of cases;
ii) a moderator computer, wherein the moderator computer is configured to display an interface operable to submit a case change request indicating that a case from the plurality of cases should be made active;
B) the management server is configured to, based on receiving the case change request, perform a set of acts comprising:
i) for each representative enabled to contribute to communications with the judge on a first communication channel at a receipt time for the case change request who is not associated with the case indicated in the case change request as the case that should be made active, deactivating that representative, wherein deactivating that representative comprises:
I) preventing that representative from contributing to communications with the judge on the first communication channel;
II) sending a representative deactivation update to the representative computer associated with that representative, wherein the representative deactivation update is operable to configure a representative computer associated with that representative to display an interface indicating that that representative cannot contribute to communications with the judge on the first communication channel; and
III) including information in a moderator interface update indicating that that representative cannot contribute to communications with the judge on the first communication channel;
ii) for each of the one or more representatives associated with the case indicated in the case change request as the case that should be made active, activating that representative, wherein activating that representative comprises:
I) enabling that representative to contribute to communications with the judge on the first communication channel;
II) sending a representative activation update to a representative computer associated with that representative, wherein the representative activation update is operable to configure the representative computer associated with that representative to display an interface indicating that that representative can contribute to communications with the judge on the first communication channel; and
III) including information in the moderator interface update indicating that that representative can contribute to communications with the judge on the first communication channel;
iii) sending the moderator interface update to the moderator computer.

4. The system of claim 3, wherein:
a) the first communication channel:
i) is an audio communication channel;
ii) is comprised by a set of external communication channels, wherein each communication channel from the set of external communication channels is associated with a server located remotely from, and in communication with, the management server;
b) the system comprises:
i) an audio server associated with the audio communication channel;
ii) a plurality of audio communication devices, wherein:
A) the plurality of audio communication devices comprises, for each user computer from the plurality of user computers, a corresponding audio communication device; and
B) each audio communication device from the plurality of audio communication devices is operable as an interface to the audio communication channel;
c) the management server is configured to, when performing either of the acts of:
i) preventing contributions to communications with the judge on the audio communication channel; or
ii) enabling contributions to communications with the judge on the audio communication channel
doing so by performing a set of acts comprising sending a request to the audio server.

5. The system of claim 4, wherein the management server is configured to execute software for, if a data structure stored by the management server representing an external permission modification is not associated with information indicating that that data structure is being processed, processing that data structure by performing acts comprising:
a) sending a request to implement the external permission modification to a server associated with a communication channel from the set of external communication channels;
b) receiving a confirmation message from the server associated with the communication channel from the set of external communication channels, wherein the confirmation message indicates that the external permission modification has been completed;
c) after receiving the confirmation message:
i) updating a set of persistence data to include a result of the external permission modification; and
ii) sending data operable to configure a representative computer which receives the data to display an interface indicating a result of the external permission modification.

6. The system of claim 5, wherein:
a) the set of persistence data comprises, for each participant from the plurality of participants, data indicating, for each communication channel from the set of external communication channels, that participant's ability to contribute to and/or access communications on that communication channel;
b) the management server is configured to, if a participant from the plurality of participants becomes disconnected from, and reconnects to, a communication channel from the set of external communication channels during the remote conference, upon reconnection by the participant to the communication channel from the set of external communication channels:
i) request that the server associated with the communication channel reconnected to by the participant restore the reconnected participant's ability to contribute to and/or access communications on that communication channel as indicated by the set of persistence data; and
ii) send, to the moderator computer and a user computer associated with the reconnected participant, data operable to update interfaces displayed by those computers to include the reconnected participant's restored ability to contribute to and/or access communications on the communication channel reconnected to by the participant.

7. The system of claim 4, wherein:
a) the interface the moderator computer is configured to display is operable to submit a subconference assignment indicating:
i) a participant from the plurality of participants; and
ii) a subconference;
b) the management server is configured to, based on receiving the subconference assignment, perform a set of acts comprising:
i) sending a subconference request to the audio server associated with the audio communication channel, wherein the subconference request requests that the participant indicated in the subconference assignment be placed into the subconference indicated in the subconference assignment;
ii) updating data indicating a set of participants placed in the subconference indicated in the subconference assignment to indicate that the participant indicated in the subconference assignment is placed in the subconference indicated in the subconference assignment; and
iii) sending, to each user computer associated with a participant from the set of participants placed in the subconference indicated in the subconference assignment, data operable to cause an interface displayed by that user computer to indicate each participant placed in the subconference indicated in the subconference assignment.

8. The system of claim 4, wherein:
a) the set of external communication channels comprises a video communication channel;
b) the management server is configured to send a set of virtual courtroom data to each user computer associated with either:
i) the judge; or
ii) a representative associated with a case identified as being active in data the management server is configured to maintain;
wherein the set of virtual courtroom data is operable to configure the user computer to which it is sent to display an interface comprising:
I) for each representative associated with the case identified as being active, an indication of that representative's ability to contribute to communications on each communication channel from the set of external communication channels; and
II) for the judge, and for each representative associated with the case identified as being active who is indicated as being able to contribute to communications on the video communication channel, a video stream captured by a video capture device corresponding to that representative.

9. The system of claim 4, wherein:
a) the management server is configured to:
i) receive, from a user computer, a text message delivery request comprising a text message body and an indication of a set of intended recipients;
ii) based on receiving the text message delivery request, send a text message update to:
A) the user computer from which the text message delivery request was received; and
B) each user computer associated with an intended recipient from the set of intended recipients indicated in the text message delivery request;
wherein the text message update is operable to configure the user computer to which it is sent to display an interface comprising the text message body;
b) each user computer associated with either:
i) the judge; or
ii) a representative associated with a case from the plurality of cases scheduled for meetings before the judge during the remote conference is operable to submit text message delivery requests indicating, as the set of intended recipients, a user associated with the moderator computer;
c) the moderator computer is operable to submit text message delivery requests indicating, as the set of intended recipients:
i) a participant in the remote conference; or
ii) all participants in the remote conference.

10. The system of claim 3, wherein the interface the moderator computer is configured to display is operable to indicate, for each participant from the plurality of participants, whether that participant is connected to the management server.

11. A method for managing a remote conference scheduled to include a plurality of cases and having a plurality of participants comprising a judge and one or more representatives for each case from the plurality of cases scheduled for inclusion in the conference, the method comprising:
a) receiving, at a management server, a case change request indicating that a case from the plurality of cases scheduled for inclusion in the conference should be made active;
b) based on receiving the case change request, the management server performing a set of acts comprising:
i) for each representative enabled to contribute to communications with the judge on a first communication channel when the case change request was received who is not associated with the case indicated in the case change request as the case that should be made active, deactivating that representative, wherein deactivating that representative comprises:
I) preventing that representative from contributing to communications with the judge on the first communication channel;
II) sending a representative deactivation update to a computer associated with that representative, wherein the representative deactivation update is operable to configure the computer associated with that representative to display an interface indicating that that representative cannot contribute to communications with the judge on the first communication channel;
III) including information in a moderator interface update indicating that that representative cannot contribute to communications with the judge on the first communication channel;
ii) for each of the one or more representatives associated with the case indicated in the case change request as the case that should be made active, activating that representative, wherein activating that representative comprises:
I) enabling that representative to contribute to communications with the judge on the first communication channel;
II) sending a representative activation update to a computer associated with that representative, wherein the representative activation update is operable to configure the computer associated with that representative to display an interface indicating that that representative can contribute to communications with the judge on the first communication channel; and
III) including information in the moderator interface update indicating that that representative can contribute to communications with the judge on the first communication channel;
iii) sending the docket interface update to a computer associated with a moderator for the remote conference.

12. The method of claim 11, wherein:
a) the first communication channel:
i) is an audio communication channel;
ii) is comprised by a set of external communication channels, wherein each communication channel from the set of external communication channels is associated with a server located remotely from, and in communication with, the management server;
b) the management server performs the acts of
i) preventing contributions to communications with the judge on the audio communication channel; and
ii) enabling contributions to communications with the judge on the audio communication channel
by performing a set of acts comprising sending a request to an audio server associated with the audio communication channel.

13. The method of claim 12, wherein the method comprises the management server executing software for, if a data structure stored by the management server representing an external permission modification is not associated with information indicating that that data structure is being processed, processing that data structure by performing acts comprising:
a) sending a request to implement the external permission modification represented by that data structure to a server associated with a communication channel from the set of external communication channels;
b) receiving a confirmation message from the server associated with the communication channel from the set of external communication channels, wherein the confirmation message indicates that the external permission modification associated with that data structure has been completed;
c) after receiving the confirmation message:
i) updating a set of persistence data to include a result of the external permission modification; and
ii) sending data operable to cause an interface displayed on a user computer associated with a participant in the remote conference to include a result of the external permission modification.

14. The method of claim 13, wherein:
a) the set of persistence data comprises, for each participant from the plurality of participants, data indicating, for each communication channel from the set of external communication channels, that participant's ability to contribute to and/or access communications on that communication channel;
b) the method comprises:
i) after deactivating a representative, receiving, at the management server and during the remote conference, a reconnection message indicating that the deactivated representative has reconnected to a communication channel from the set of external communication channels;
ii) based on receiving the reconnection message:
A) retrieving persistence information for the deactivated representative, the persistence information indicating that the deactivated representative should be prevented from contributing to communications with the judge on the external communication channel;
B) based on the persistence information, send a request to the server associated with the communication channel reconnected to by the deactivated participant indicating that the deactivated participant should be prevented from contributing to communications with the judge on that communication channel; and
C) send, to computers associated with
I) the moderator; and
II) the deactivated representative,
data operable to update interfaces displayed by those computers to indicate that the deactivated participant had reconnected to, but could not contribute to communications with the judge on, the external communication channel.

15. The method of claim 12, wherein the method comprises:
a) receiving, at the management server, a subconference assignment indicating:
i) a participant from the plurality of participants; and
ii) a subconference;
b) the management server, based on receiving the subconference assignment, performing a set of acts comprising:
i) sending a subconference request to the audio server associated with the audio communication channel, wherein the subconference request requests that the participant indicated in the subconference assignment be placed into the subconference indicated in the subconference assignment;
ii) updating data indicating a set of participants placed in the subconference indicated in the subconference assignment to indicate that the participant indicated in the subconference assignment is placed in the subconference indicated in the subconference assignment; and
iii) for each participant from the set of participants placed in the subconference indicated in the subconference assignment, sending subconference interface data to a computer associated with that participant, wherein the subconference interface data is operable to cause an interface displayed by the computer associated with that participant to indicate each participant placed in the subconference indicated in the subconference assignment.

16. The method of claim 15, wherein the method comprises, while the participant indicated in the subconference assignment is in the subconference indicated in the subconference assignment:
a) receiving, at the management server, a second subconference assignment, the second subconference assignment indicating:
i) a second participant from the plurality of participants; and
ii) a second subconference;
b) the management server, based on receiving the second subconference assignment, performing a set of acts comprising:
i) sending a second subconference request to the audio server associated with the audio communication channel, wherein the second subconference request requests that the second participant indicated in the second subconference assignment be placed into the second subconference indicated in the second subconference assignment;
ii) updating data indicating a set of participants placed in the second subconference indicated in the second subconference assignment to indicate that the second participant indicated in the second subconference assignment is placed in the second subconference indicated in the second subconference assignment; and
iii) for each participant from the set of participants placed in the second subconference indicated in the second subconference assignment, sending subconference interface data to a computer associated with that participant, wherein the subconference interface data is operable to cause an interface displayed by the computer associated with that participant to indicate each participant placed in the second subconference indicated in the second subconference assignment.

17. The method of claim 12, wherein:
a) the set of external communication channels comprises a video communication channel;
b) the management server is configured to send a set of virtual courtroom data to computers associated with either:
i) the judge; or
ii) a representative associated with a case identified as being active in data maintained by the management server;
wherein the set of virtual courtroom data is operable to configure the computer to which it is sent to display an interface comprising:
I) for each representative associated with the case identified as being active, an indication of that representative's ability to contribute to communications on each communication channel from the set of external communication channels; and
II) for the judge, and for each representative associated with the case identified as being active who is indicated as being able to contribute to communications on the video communication channel, a video stream captured by a video capture device corresponding to that representative.

18. The method of claim 12, comprising the management server:
a) receiving a text message delivery request from a computer associated either with the moderator or with a participant from the plurality of participants, wherein the text message delivery request comprises a text message body and an indication of a set of intended recipients;
b) sending a text message update to:
i) the computer from which the text message delivery request was received; and
ii) for each intended recipient from the set of intended recipients indicated in the text message delivery request, a computer associated with that intended recipient;
wherein the text message update is operable to configure the computer to which it is sent to display an interface comprising the text message body.

19. The method of claim 12, comprising the management server:
a) receiving a text message delivery request from the moderator, wherein the text message delivery request from the moderator comprises:
i) an indication of a set of intended recipients consisting of a single participant in the remote conference who has not connected to the audio communication channel;
ii) a text message body including information for the single participant in the remote conference who has not connected to the audio communication channel to use to connect to the audio communication channel;
b) sending a text message update to a computer associated with the participant in the remote conference who has not connected to the audio communication channel, wherein the text message update is operable to configure that computer to display an interface comprising the text message body; and
c) after sending the text message update, receiving a message from the audio server confirming connection to the audio communication channel by the participant associated with the computer to which the text message update was sent.

20. The method of claim 11, wherein the management server is configured to send connection status data to a computer associated with the moderator, wherein the connection status data is operable to configure the computer associated with the moderator to display an interface indicating, for each participant in the remote conference, whether that participant is connected to the management server.

21. The method of claim 11, wherein:
a) the plurality of cases comprises a first case and a second case;
b) the case change request received by the management server is a first case change request in a series of case change requests during the remote conference;
c) the series of case change requests comprises a second case change request received at the management server after the first case change request;
d) at the time the first case change request is received at the management server, the first case is active;
e) the first case change request indicates that the second case should be made active;
f) the second case change request indicates that the first case should be made active;
g) the method comprises the management server, based on receiving the second case change request, performing a set of acts comprising:
i) for each representative enabled to contribute to communications with the judge on a first communication channel when the case change request was received who is not associated with the first case, deactivating that representative, wherein deactivating that representative comprises:
I) preventing that representative from contributing to communications with the judge on the first communication channel;
II) sending a representative deactivation update to a computer associated with that representative, wherein the representative deactivation update is operable to configure the computer associated with that representative to display an interface indicating that that representative cannot contribute to communications with the judge on the first communication channel;
III) including information in a moderator interface update indicating that that representative cannot contribute to communications with the judge on the first communication channel;
ii) for each of the one or more representatives associated with the first case, activating that representative, wherein activating that representative comprises:
I) enabling that representative to contribute to communications with the judge on the first communication channel;
II) sending a representative activation update to a computer associated with that representative, wherein the representative activation update is operable to configure the computer associated with that representative to display an interface indicating that that representative can contribute to communications with the judge on the first communication channel; and
III) including information in the moderator interface update indicating that that representative can contribute to communications with the judge on the first communication channel;
iii) sending the docket interface update to the computer associated with the moderator for the remote conference.
